(19) United States
(12) Patent Application Publication
(10) Pub. No.: US 2005/0084010 A1
(43) Pub. Date: Apr. 21, 2005

(54) Video encoding method

(75) Inventors: Marion Benetiere, Eindhoven (NL); Vincent Bottreau, Paris (FR); Nicolas Poisson, Montigny le Bretonneux (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/499,942

(22) PCT Filed: Dec. 20, 2002
(86) PCT No.: PCT/IB02/05669

(30) Foreign Application Priority Data
Dec. 28, 2001 (EP) 01403384.9
Aug. 7, 2002 (EP) 02291984.9

(51) Int. Cl. H04N 7/12

(52) U.S. Cl. 375/240.12

(57) ABSTRACT

The invention, related to an encoding method applied to a video sequence divided into successive groups of frames (GOFs) themselves subdivided into successive couples of frames (COFs), comprises a motion estimation step applied to each couple of frames (COF), a motion-compensated three-dimensional (3D) subband decomposition step applied to each GOF, using a motion-compensated temporal analysis, based on said motion vector fields, and a spatial wavelet transform for defining a decomposition into spatio-temporal subbands, a coding step, for quantizing and coding said spatio-temporal subbands, and a control step. According to the invention, the direction of the motion estimation step for the successive couples of frames of any concerned GOF is chosen according to a scheme which is preferably either an alternate one, for the successive couples of frames, or an arbitrarily modified scheme in which the motion estimation and compensation operations are concentrated on a limited number of said successive couples of frames, selected on the basis of an energy criterion.

### FIELD OF THE INVENTION

The present invention generally relates to the field of data compression and, more specifically, to an encoding method applied to a video sequence divided into successive groups of frames (GOFs) themselves subdivided into successive couples of frames (COFs) including a reference frame and a current frame, said method comprising the following steps:
(A) a motion estimation step applied to each couple of frames (COF) of each GOF, for defining a motion vector field between the reference and current frames of said COF;
(B) a motion-compensated three-dimensional (3D) subband decomposition step applied to each GOF, using, for defining a decomposition into spatio-temporal subbands, a motion-compensated temporal analysis, based on said motion vector fields, and a spatial wavelet transform;
(C) a coding step, for quantizing and coding said spatio-temporal subbands;
(D) a control step, for defining, on the basis of a buffer status observed at the output of said coding step, a bitrate allocation to be shared between said motion vector fields and said spatio-temporal subbands.

### BACKGROUND OF THE INVENTION

Although network bandwidth and storage capacity of digital devices are increasing rapidly, video compression still plays an essential role due to the exponential growth in size of multimedia content. Moreover, many applications require not only a high compression efficiency, but also an enhanced flexibility. For instance, SNR scalability is highly needed to transmit a video over heterogeneous networks, and spatial/temporal scalability is required to make a same compressed video bitstream that may be decoded by different types of digital terminals according to their computational, display and memory capabilities.

Current standards like MPEG-4 have implemented a limited scalability in a predictive DCT-based framework through additional high-cost layers. More efficient solutions, based on a 3D wavelet decomposition followed by a hierarchical encoding of the spatio-temporal trees, have been recently proposed as an extension of still image coding techniques to video coding ones. A 3D, or (2D+t), wavelet decomposition of the sequence of frames considered as a 3D volume provides a natural spatial resolution and frame rate scalability, while the in-depth scanning of the generated coefficients in the hierarchical trees (the coefficients generated by the wavelet transform constitute a hierarchical pyramid in which the spatio-temporal relationship is defined thanks to 3D orientation trees evidencing the parent-offspring dependencies between coefficients) and the progressive bitplane encoding technique lead to the desired quality scalability. A higher flexibility is thus obtained at a reasonable cost in terms of coding efficiency.

Some prior implementations are based on that approach. In such implementations, the input video sequence is generally divided into Groups of Frames (GOFs), and each GOF, itself subdivided into successive couples of frames (which are as many inputs for a so-called Motion-Compensated Temporal Filtering, or MCTF module), is first motion-compensated (MC) and then temporally filtered (TF) as shown in FIG. 1. The resulting low frequency (L) temporal subbands of the first temporal decomposition level are further filtered (TF), and the process stops when there is only two temporal low frequency subbands left (the root temporal subbands), each one representing a temporal approximation of the first and second halves of the GOF. In the example of FIG. 1, the frames of the illustrated group are referenced F1 to F8, and the dotted arrows correspond to a high-pass temporal filtering, while the other ones correspond to a low-pass temporal filtering. Three stages of decomposition are shown (L and H=first stage; LL and LH=second stage; LLL and LLH=third stage). At each temporal decomposition level of the illustrated group of 8 frames, a group of motion vector fields is generated (MV4 at the first level, MV3 at the second one, MV2 at the third one).

When a Haar multiresolution analysis is used for the temporal decomposition, since one motion vector field is generated between every two frames in the considered group of frames at each temporal decomposition level, the number of motion vector fields is equal to half the number of frames in the temporal subband, i.e. four at the first level of motion vector fields, two at the second one, and one at the third one. Motion estimation (ME) and motion compensation (MC) are only performed every two frames of the input sequence, and the total number of ME/MC operations required for the whole temporal tree resulting from this MCTF operation is roughly the same as in a predictive scheme. Using these very simple filters, the low frequency temporal subband represents a temporal average of the input couples of frames, whereas the high frequency one contains the residual error after the MCTF step.

In such a 3D video coding scheme, the ME/MC operations are generally performed in the forward way, i.e. when performing the motion compensation into a couple of frames (i, i+1), i is displaced in the direction of motion towards i+1. If, as shown in the example of FIG. 1, one considers an input GOF of eight frames and three successive temporal filtering steps, the temporal filtering operation takes a reference frame and a current frame as an input (for example F1 and F2) and delivers a low (L) frequency subband and a high (H) frequency subband. As said above, using Haar filters, the low frequency subband provides a temporal average of the input couples of frames and the high frequency one the residual error from the motion compensation stage. The operation is repeated between the two following frames, and so on for each successive couple of frames, which leads to four temporal low frequency subbands. The temporal filtering operation is similarly repeated between each successive couple of low frequency subbands at the next temporal level, and so on. At the lowest temporal resolution level, there are therefore two low frequency subbands representing respectively each one half of the GOF and the other one. However, the way the temporal filtering operation is performed in practice induces some deviation of the averages towards references, that is a low frequency subband contains more information about the reference than the current frame. Since the ME/MC operations are performed in the forward direction, the same shift affects each temporal decomposition level and is observed within each half of the GOF.

This behaviour can be explained by the following temporal filtering equations (1) and (2), giving the MCTF equations for low and high frequency subbands and in which the motion vectors are subtracted from the coordinates of both reference and low frequency subbands (A=reference frame; B=current frame):

$$\begin{matrix}L ( i - {mv}_{x} , j - {mv}_{y} ) = \frac{1}{\sqrt{2}} [ B ( i , j ) + A ( i - {mv}_{x} , j - {mv}_{y} ) ] & ( 1 ) \\ H ( i , j ) = \frac{1}{\sqrt{2}} [ B ( i , j ) - A ( i - {mv}_{x} , j - {mv}_{y} ) ] & ( 2 )\end{matrix}$$

Assuming that the prediction error is null, one has L=A.\sqrt{2}. Therefore, the low frequency subband is very similar to the reference frame. It will then be shown that, in addition, with a not perfect reconstruction, these MCTF equations always better reconstruct the reference than the current frame.

The process of MCTF combined with block matching ME is described in FIG. 2. Block boundaries (BBY) are delineated by horizontal lines. Matched blocks in the reference frame A may overlap with neighbouring blocks. In this case, only a subset of this reference frame is used for the MC operation in the current frame B, i.e. some pixels are filtered more than once and others not filtered at all: these pixels are respectively called double connected and unconnected. If only motion-compensated filtering outputs are encoded and transmitted, then some unconnected pixels may be left out (typically about 3-5% of the pixels), and they may seriously affect both the overall coding gain and the subjective video quality. To reduce the problem of unconnected pixels, it has been proposed, in “Motion-compensation 3D subband coding of video”, S. J. Choi and J. W. Woods, IEEE Transactions on Image Processing, vol.8, no 2, February 1999, pp.155-167, a method that consists in locating the low frequency subband to the position of the reference frame, while putting the high frequency subband at the corresponding position in the current frame (see equations (1) and (2)). This way, the high frequency subbands have the smallest energy as possible and are compatible with a Displaced Frame Difference (DFD) value for the unconnected pixels (see equations (3) and (4), corresponding to the MCTF for the unconnected pixels):

$$\begin{matrix}L ( i , j ) = \frac{2}{\sqrt{2}} [ A ( i , j ) & ( 3 ) \\ H ( i , j ) = \frac{1}{\sqrt{2}} [ B ( i , j ) - A ( i - {mv}_{x} , j - {mv}_{y} ) ] & ( 4 )\end{matrix}$$

This processing does not however completely solve the problem of unconnected pixels, since it can be shown that, when the video bitstream is only partly decoded, they may still induce some perturbations in the spatio-temporal tree reconstruction.

Considering then a couple of low and high frequency subbands, it is supposed that there was no transmitted wavelet coefficient for the high frequency one (H=0). The reconstruction equations for A (reference) and B (current) frames, which are:

$$\begin{matrix}{A}^{′} ( i - {mv}_{x} , j - {mv}_{y} ) = \frac{1}{\sqrt{2}} [ L ( i - {mv}_{x} , j - {mv}_{y} ) - H ] & ( 5 ) \\ {B}^{′} ( i , j ) = \frac{1}{\sqrt{2}} [ L ( i - {mv}_{x} , j - {mv}_{y} ) + H ] , & ( 6 ) \\ become \text{:} & \\ \begin{matrix}{A}^{′} ( i - {mv}_{x} , j - {mv}_{y} ) = \frac{1}{\sqrt{2}} [ L ( i - {mv}_{x} , j - {mv}_{y} ) ] \\ = \frac{1}{2} [ B ( i , j ) + A ( i - {mv}_{x} , j - {mv}_{y} ) ]\end{matrix} & ( 7 ) \\ \begin{matrix}{B}^{′} ( i , j ) = \frac{1}{\sqrt{2}} [ L ( i - {mv}_{x} , j - {mv}_{y} ) ] \\ = \frac{1}{2} [ B ( i , j ) + A ( i - {mv}_{x} , j - {mv}_{y} ) ]\end{matrix} & ( 8 )\end{matrix}$$

which correspond respectively to reconstructed reference and current frames with no coefficient in the decoded high frequency subband. The corresponding reconstruction is then given by the equations (9) and (10):

$$\begin{matrix}\begin{matrix}\vert {A}^{′} - A \vert ( i - {mv}_{x} , j - {mv}_{y} ) = \vert \frac{1}{2} [ B ( i , j ) - A ( i - {mv}_{x} j - {mv}_{y} ) ] \vert \\ = \vert \frac{ɛ}{2} \vert\end{matrix} & ( 9 ) \\ \vert {B}^{′} - B \vert ( i , j ) = \vert \frac{1}{2} [ A ( i - {mv}_{x} j - {mv}_{y} ) - B ( i , j ) ] \vert = \vert \frac{ɛ}{2} \vert & ( 10 )\end{matrix}$$

where ε is the prediction error. This proves that the error is equally distributed between A and B frames.

For unconnected pixels, however, the conclusions are not the same. The reconstruction equations (11) and (12):

$$\begin{matrix}{A}^{′} ( i , j ) = \frac{1}{\sqrt{2}} L ( i , j ) & ( 11 ) \\ {B}^{′} ( i , j ) = - \frac{1}{\sqrt{2}} [ L ( i - {mv}_{x} , j - {mv}_{y} ) + H ] & ( 12 )\end{matrix}$$

become, when H=0:
A′(i,j)=A(i,j) (13)

$${B}^{′} ( i , j ) = - \frac{1}{\sqrt{2}} [ L ( i - {mv}_{x} , j - {mv}_{y} ) ] \qquad ( 14 )$$

which gives, for the reconstruction error, for unconnected pixels of reference and current frames with no coefficient in the decoded high frequency subband, the following equations (15) and (16):
|A′−A|(i,j)=0 (15)

$$\vert {B}^{′} - B \vert ( i , j ) = - \frac{ɛ}{2} . \qquad ( 16 )$$

In this case, the error is now entirely put on the current frame. Due to cascaded forward ME/MC, said error is propagating in depth inside the temporal tree, leading to a quality drop within each half of the GOF and inducing some annoying visual effects.

This kind of drift is really an issue in the (2D+t) video coding scheme, since balanced temporal decomposition is a prerequisite for efficient coding of wavelet coefficients (coefficients of the root subbands have offspring in the highest levels, and an assumption made for data compression is that the coefficients of the same line have a similar behaviour).

Moreover, in the 3D subband coding approach, the temporal distance between these reference and current frames ((ref,cur) couple) increases with deeper temporal levels. If the temporal distance between two successive frames is considered as equal to 1, it is equal to 2 if there is one frame between them, and so on. Since, as explained just above, low frequency temporal subbands are very close to the input reference frames, it will be considered that they are located at the same instant as their reference, and, consequently, the notion of temporal distance can be simply extended to them. Based on this statement, it is possible to evaluate the temporal distance between frames (or subbands) at each temporal resolution level. As shown in FIG. 3, for a forward scheme, at temporal level n≧1, the distance between frames equals 2ⁿ. There are many factors contributing to the quality of motion compensation, but one of the most important is precisely the distance between frames. If said distance is small, the frames are expected to be more similar and the ME/MC is more efficient, while, when the frame to be motion-compensated is very far away from its reference, the error energy of the residual image (the high frequency subband) remains high. In this last situation, the decoding of the coefficients of said residual image is therefore very costly. If the encoding operation is stopped before a perfect reconstruction is obtained, which occurs most of the time (in a scalable scheme, any kind of bitrate is targeted), the high frequency subbands are very likely to contain some artefacts, and the reconstructed video is degraded.

### SUMMARY OF THE INVENTION

It is therefore the object of the invention to propose a video encoding method with which the shift leading to these artefacts is at least reduced.

To this end, the invention relates to a video encoding method such as defined in the introductory part of the description and which is moreover characterized in that the direction of the motion estimation step is modified according to the considered couple of frames in the concerned GOF.

In an advantageous implementation of said encoding method, the direction of the motion estimation step is alternately a backward one and a forward one for the successive couples of frames of any concerned GOF.

This method provides closer couples of reference and current frames for ME/MC at deeper temporal decomposition levels and it also leads to more balanced temporal approximations of the GOF at each temporal resolution level. A better repartition of the bit budget between temporal subbands is therefore obtained, and the global efficiency on the whole GOF is improved. Especially at low bitrates, the overall quality of the reconstructed video sequence is improved.

In another implementation of the encoding method, the direction of the motion estimation step for the successive couples of frames of any concerned GOF is chosen according an arbitrarily modified scheme in which the motion estimation and compensation operations are concentrated on a limited number of said couples of frames, selected according to an energy criterion.

By deciding to favor some frames to the detriment of the other ones inside a GOF, this method allows to get an improved coding efficiency in a particular temporal area.

### BRIEF DESCRIPTION OF THE DRAWINGS

The invention will now be described in a more detailed manner, with reference to the accompanying drawings in which:

FIG. 1 illustrates a temporal subband decomposition with motion compensation;

FIG. 2 illustrates the problem of unconnected and double connected pixels;

FIG. 3 illustrates a conventional way of performing the motion compensation within a GOF;

FIG. 4 illustrates in a first implementation of the invention an improved way of performing the motion compensation;

FIG. 5 illustrates the comparison between the solutions of FIGS. 3 and 4;

FIG. 6 illustrates in a second implementation of the invention another improved way of performing the motion compensation.

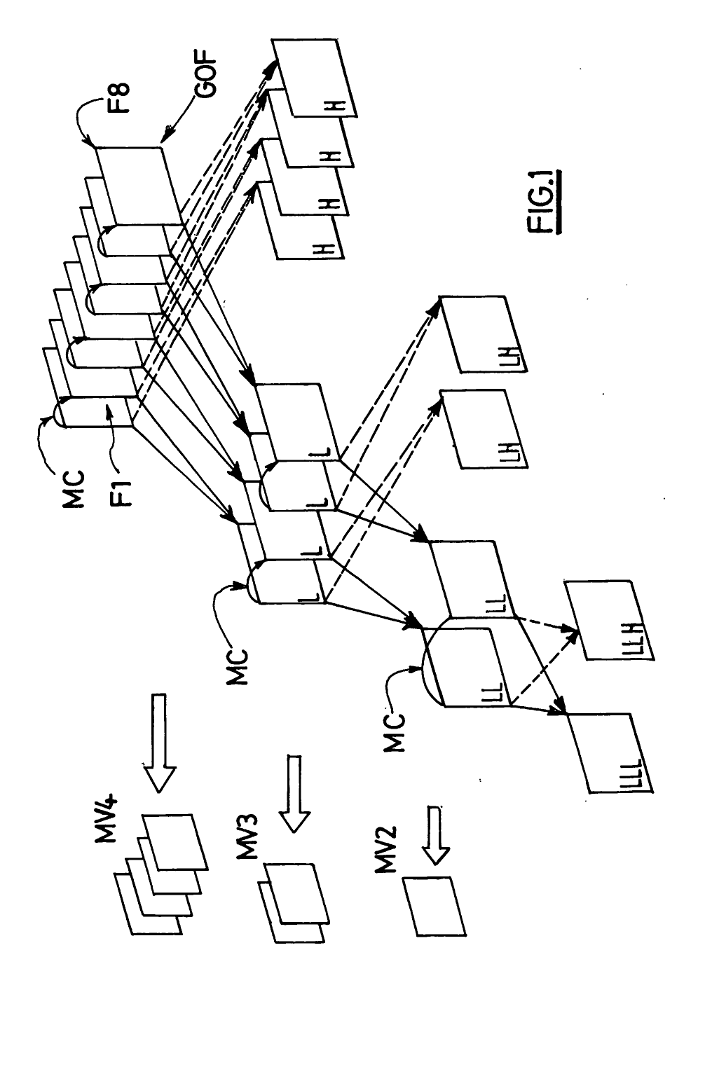

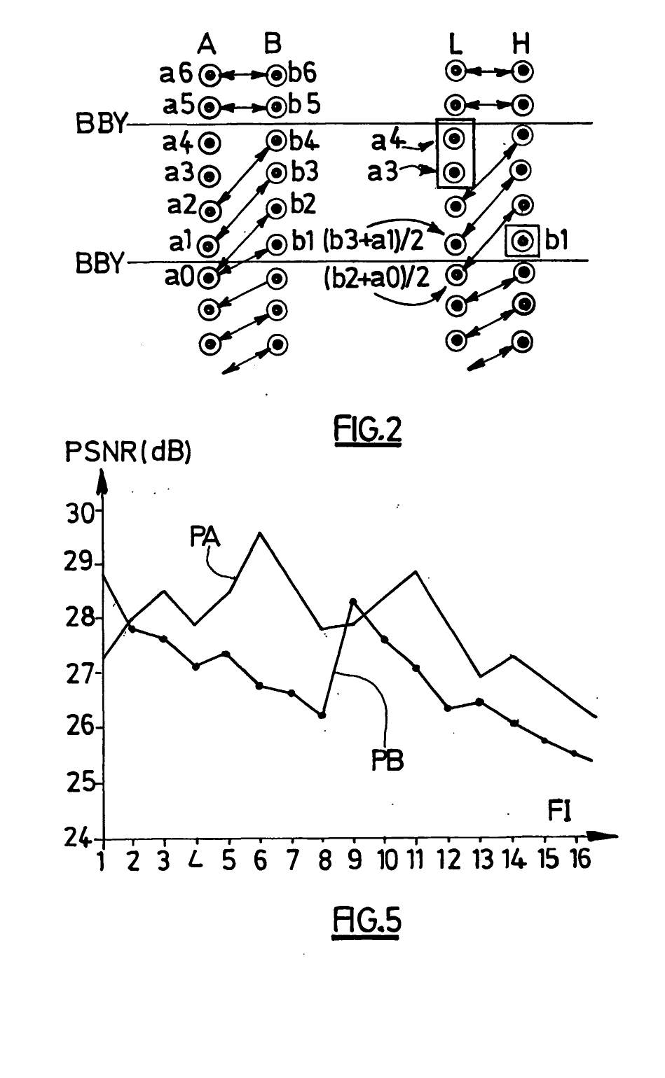

### DETAILED DESCRIPTION

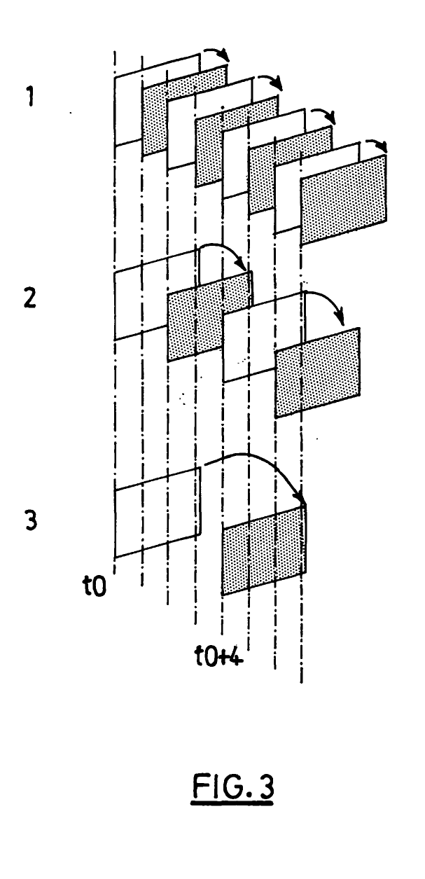

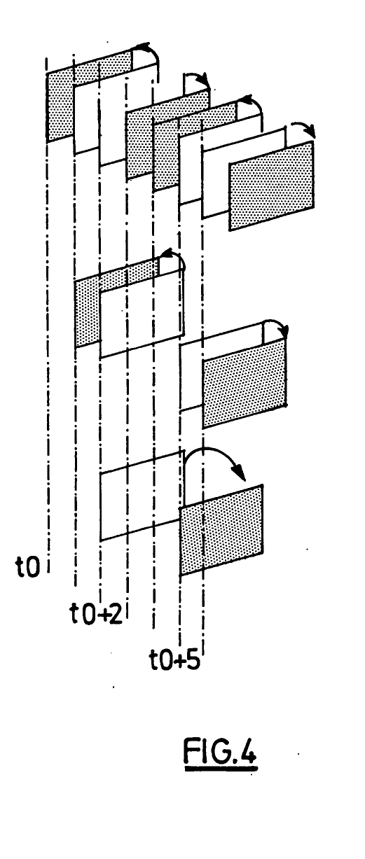

While in the 3D video coding scheme described above (in relation with FIG. 3), the ME/MC operations are performed in the forward way, it is now proposed, according to the invention, to modify the direction of the motion estimation according to the considered couple of frames. For example, in a first and advantageous implementation, it is proposed to alternate the motion estimation direction of the successive frame couples within the GOF, as shown in FIG. 4, starting with a backward one. This technical solution allows to use closer couples of frames at the deeper temporal levels (n>1): at temporal level n=1, the distance between the two frames of a couple is then reduced to 1, instead of 2 in the classical case, at temporal level n=2, this distance is reduced to 3 instead of 4, and so on for the following temporal levels. In a more general way, to alternate the motion estimation directions leads to the following equations:

$$\{ \begin{matrix}{d}_{intra} = 1 , for n = 1 & ( 17 ) \\ {d}_{intra} = {2}^{n - 1} + 1 , for n > 1 & ( 18 ) \\ {d}_{inter} = {2}^{n} + 1 & ( 19 ) \end{matrix}$$

in which n is the temporal decomposition level, dᵢₙₜᵣₐ represents the intra frame temporal distance within a GOF, or (ref,cur) couple distance, and dᵢₙₜₑᵣ represents the inter frame temporal distance between two successive couples in number of frame units.

With this solution, the lowest frequency temporal subbands are shifted towards the middle of the GOF, leading to a more balanced temporal decomposition. The quality degradation due to unconnected pixels is still present but no more cumulative with the successive temporal levels. The use of such a modified ME/MC in a 3D subband video compression scheme allows a clear and noticeable improvement of the coding efficiency at low bitrates, as illustrated in FIG. 5 showing in the case of the invention (case PA) the typical (average) profile of the evolution of the PSNR (Peak Signal/Noise Ratio) with respect to the frame index FI in a GOF (tested on the well known Foreman sequence), compared to the case of forward MC only (case PB). The average gain in quality is about 1 dB, and, compared to the forward-only curve, the quality is better shared out all along the GOF. It can be noted that the frames of highest quality are those whose corresponding low frequency subband is reused as a reference at next temporal level. This is not surprising since reference subbands/frames are always better reconstructed than high frequency ones when the decoding process is stopped before the end of the bitstream. This alternate ME/MC scheme guarantees to use the best quality references available at each temporal level.

However, when considering an extract from a sequence of frames in which the first part (for instance a first GOF) contains a high amount of motion (due to a camera panning for instance) while there is almost no more motion in the second part (for instance a second GOF) of said extract (which shows for example a house), the following remarks can be made. At low bitrates, the first part of the extract (the first GOF) cannot be encoded correctly due to the high degree of motion: visually, the reconstructed video contains a lot of very annoying block artefacts induced by the block matching ME and the poor error encoding (one could get rid of these artefacts only at very high bitrates). It may be then proposed to change the motion estimation direction according to the motion content. However, if the considered sequence is coded with a classical forward scheme or with the alternate scheme, the end of the first GOF (this first GOF contains a high amount of motion, but said motions stops at the end of the GO and said end is therefore rather still) is of poor quality compared to the similar frames in the second GOF (completely still). The problem of these “still” frames of the end of the first GOF is that they suffer from being clustered in a same GOF with some previous frames which contain a high amount of motion.

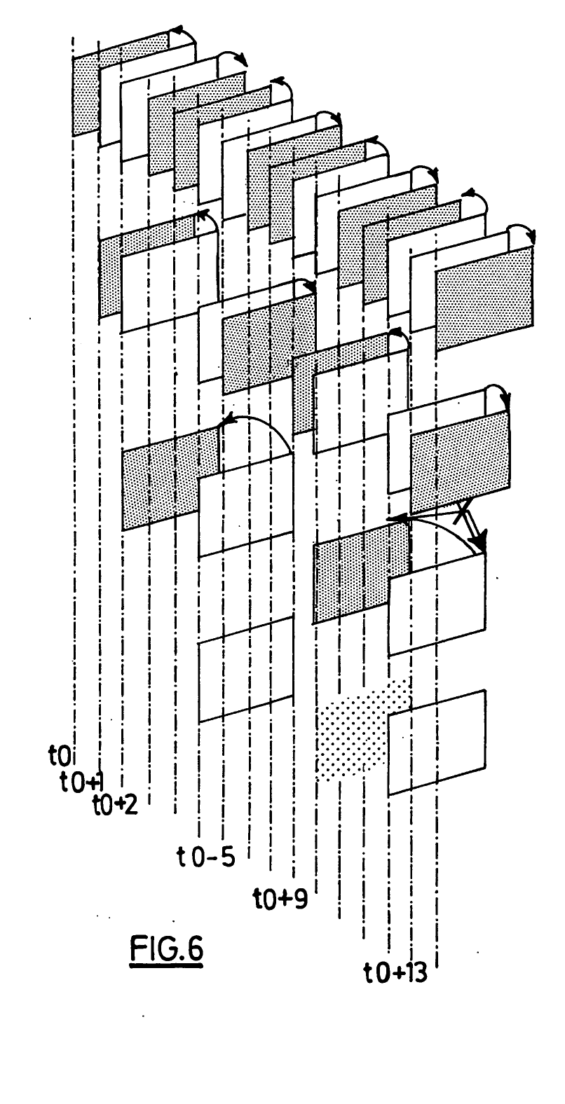

It may then proposed, on the basis of an energy criterion, to concentrate the ME and MC operations on the successive frames which, at said end of the first GOF, are quite similar (since they are still), and to “sacrify” the middle ones because they cannot be coded with a good quality anyway (the maximum bitrate allowed being not sufficient). An implementation of this solution is given in FIG. 6. It can be really observed, when comparing this last strategy with previous ones (or comparing the quality of the reconstructed frames in these various situations), that a quality improvement of the last still frames of the first GOF indeed obtained to the detriment of the previous frames in the same first GOF. Since this content-based ME/MC direction strategy proves to bring improvements in terms of coding efficiency and visual quality, it is of interest to be able to decide which ME/MC scheme fits the best the current GOF. For that evaluation, an energy criterion may be chosen, for instance a criterion based on the amount of energy contained in the high frequency temporally filtered subband obtained in the decomposition process.

1. An encoding method applied to a video sequence divided into successive groups of frames (GOFs) themselves subdivided into successive couples of frames (COFs) including a reference frame and a current frame, said method comprising the following steps:
(A) a motion estimation step applied to each couple of frames (COF) of each GOF, for defining a motion vector field between the reference and current frames of said COF;
(B) a motion-compensated three-dimensional (3D) subband decomposition step applied to each GOF, using, for defining a decomposition into spatio-temporal subbands, a motion-compensated temporal analysis, based on said motion vector fields, and a spatial wavelet transform;
(C) a coding step, for quantizing and coding said spatio-temporal subbands;
(D) a control step, for defining, on the basis of a buffer status observed at the output of said coding step, a bitrate allocation to be shared between said motion vector fields and said spatio-temporal subbands;
said method being further characterized in that the direction of the motion estimation step is modified according to the considered couple of frames in the concerned GOF.

2. An encoding method according to claim 1, in which the direction of the motion estimation step is alternately a backward one and a forward one for the successive couples of frames of any concerned GOF.

3. An encoding method according to claim 1, in which the direction of the motion estimation step for the successive couples of frames of any concerned GOF is chosen according an arbitrarily modified scheme in which the motion estimation and compensation operations are concentrated on a limited number of said couples of frames, selected on the basis of an energy criterion.
